(19) United States
(12) Patent Application Publication
(10) Pub. No.: US 2014/0076417 A1
(43) Pub. Date: Mar. 20, 2014

(54) QUICKLY-OPERATED ADAPTOR

(71) Applicant: I-Pao LIN, Taichung City (TW)

(72) Inventor: I-Pao LIN, Taichung City (TW)

(21) Appl. No.: 13/617,037

(22) Filed: Sep. 14, 2012

(51) Int. Cl. F16K 43/00

(52) U.S. Cl. 137/315.01

(57) ABSTRACT

A quickly-operated adaptor is provided. A blocking member is movable in the main body. When a joint of a gas-communicating member is received in an outlet chamber to drive the blocking member, a positioning sleeve positions the joint. The gas-communicating mechanism is movable between a third position and a fourth position. When the gas-communicating mechanism is located in the third position, the outlet chamber is communicated with a gas-releasing chamber via the gas-communicating mechanism. Whereby, spurting of the joint caused by residual of the gas can be prevented, and it is effective to unblock or block the gas flow in the gas-communicating mechanism simply via adjustment of a slidable sleeve.

### BACKGROUND OF THE INVENTION

1. Field of the Invention

The present invention relates to a quickly-operated adaptor, more particularly, to a quickly-operated adaptor having a slidable sleeve.

2. Description of the Prior Art

A conventional quickly-operated adaptor is shown in FIG. 1. The conventional quickly-operated adaptor includes a main body 7, a blocking member 8 and a positioning sleeve 10.

The main body 7 includes a tube 71 which includes an inlet end and an outlet end corresponding thereto. An outlet chamber 711 is formed in the tube 71 and near the outlet end, and an inlet chamber 712 is formed in the tube 71 and near the inlet end. The outlet chamber 711 is adapted for receiving a joint A of a gas-communicating member. A positioning hole 713 is formed in the tube 71 and near the outlet end.

The blocking member 8 is disposed in the tube 71 and movable between a first position and a second position. When the blocking member 8 is located in the first position, the blocking member 8 blocks the positioning hole 713. When the blocking member 8 is located in the second position, the blocking member 8 unblocks the positioning hole 713.

A passageway 9 is communicated with the outlet chamber 711. The passageway 9 is radially formed at one end of the blocking member 8 near the inlet chamber 712. When the blocking member 8 is located in the first position, the outlet chamber 711 is uncommunicated with the inlet chamber 712. When the blocking member 8 is located in the second position, the outlet chamber 711 is communicated with the inlet chamber 712 via the passageway 9. A hollow blocking plate 714 is disposed in the tube 71 and a washer 715 is disposed around the blocking member 8, so that the outlet chamber 711 and the inlet chamber 712 are isolated and uncommunicated with each other.

The positioning sleeve 10 is disposed around the main body 7 and near the outlet end, and the positioning sleeve 10 is slidable between a fifth position and a sixth position. The positioning sleeve 10 further includes a positioning mechanism and a second elastic member. The second elastic member is abutted between the positioning sleeve 10 and the main body 7 so as to assist in biasing of the positioning sleeve 10 toward the outlet end of the tube 71. When the positioning sleeve 10 moves toward the outlet end of the tube 71 to the sixth position, the positioning mechanism positions the joint A of the gas-communicating member received in the tube 71 via the positioning hole 713.

This kind of the conventional quickly-operated adaptor has deficiencies in use. An operator must control a switch or vale of a gas-supplying device to block the gas flow in the quickly-operated adaptor, thus resulting in inconvenience of necessary movement of the operator to the gas-supplying device. Additionally, when proceeds with a work requiring great precision, since the gas flow cannot be blocked promptly, the required precision cannot be achieved and it might cause the spurting of the joint of the gas-communicating member to injure the operator when the joint is disengaged.

The present invention is, therefore, arisen to obviate or at least mitigate the above mentioned disadvantages.

### SUMMARY OF THE INVENTION

The object of the present invention is to provide a quickly-operated adaptor, in which it is effective to unblock or block the gas flow in a gas-communicating mechanism via adjustment of a slidable sleeve, so as to improve issues of the requirement of a re-disengagement with a device or the controlling of unblocking or blocking the gas flow in a gas-supplying device.

Another object of the present invention is to provide a quickly-operated adaptor which includes a gas-releasing structure to provide a buffering effect so as to prevent the joint of the gas-communicating member from accidently spurting out due to the pressure of the residual of the gas.

To achieve the above and other objects, a quickly-operated adaptor of the present invention includes a main body, a blocking member, a first elastic member, a gas-communicating mechanism, a slidable sleeve and a positioning sleeve.

The main body includes a tube which includes an inlet end and an outlet end corresponding thereto. An inlet chamber is formed in the tube and near the inlet end, and an outlet chamber is formed in the tube and near the outlet end. The outlet chamber is adapted for receiving a joint of a gas-communicating member, the main body includes a gas-releasing chamber therein, and the tube is formed with a positioning hole near the outlet end.

The blocking member is disposed in the tube and being movable between a first position and a second position.

The first elastic member is abutted between the main body and the blocking member for assisting in biasing of the blocking member toward the first position.

The gas-communicating mechanism is movable between a third position and a fourth position and includes a passageway communicated with the outlet chamber. When the gas-communicating mechanism is located in the third position, the outlet chamber is communicated with the gas-releasing chamber via the passageway and uncommunicated with the inlet chamber. When the gas-communicating mechanism is located in the fourth position, the outlet chamber communicates with the inlet chamber via the passageway.

The slidable sleeve is disposed around the main body and near the inlet end, and the gas-releasing chamber is formed between the slidable sleeve and the tube. An inlet passageway is formed between the slidable sleeve and the tube. The inlet passageway and the inlet chamber are communicated with each other, and the passageway is formed in the tube. The gas-communicating mechanism is movable between the third position and the fourth position via sliding the slidable sleeve. When the gas-communicating mechanism is located in the third position, the passageway is communicated with the gas-releasing chamber and uncommunicated with the inlet passageway. When the gas-communicating mechanism is located in the fourth position, the passageway is communicated with the inlet passageway and uncommunicated with the gas-releasing chamber.

The positioning sleeve is disposed around the main body and near the outlet end, and is slidable between a fifth position and a sixth position.

When the blocking member is located in the first position, the positioning sleeve is unmovable to the sixth position, and when the blocking member is moved to the second position, the positioning sleeve is moved to the sixth position.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a cross-sectional view of a conventional adaptor;

FIG. 2 is a cross-sectional view of a first embodiment of the present invention;

FIG. 3 is a view showing a quickly-operated adaptor in use according to the first embodiment of the present invention; and

FIG. 4 is another view showing the quickly-operated adaptor in use according to the first embodiment of the present invention.

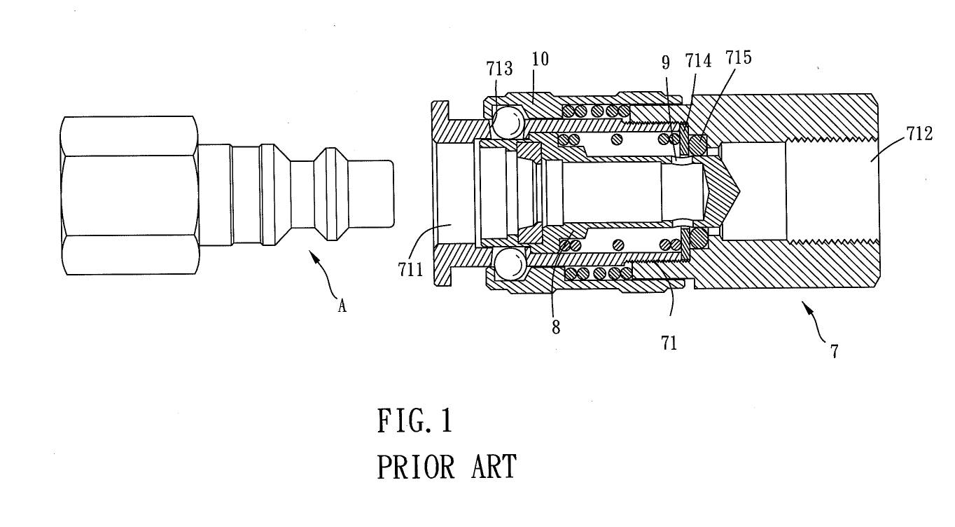

### DETAILED DESCRIPTION OF THE PREFERRED EMBODIMENTS

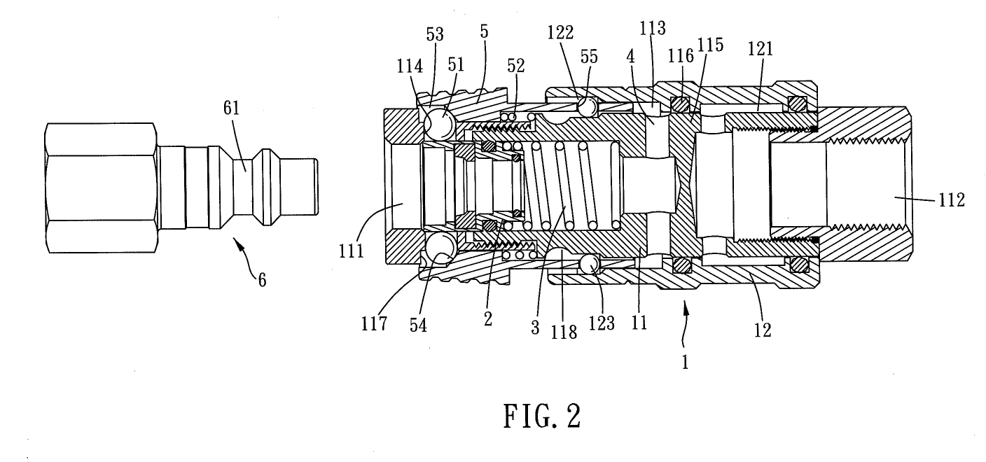

As shown in FIGS. 2 to 4, a quickly-operated adaptor of the present includes a main body 1, a blocking member 2, a first elastic member 3, a gas-communicating mechanism and a positioning sleeve 5. The main body 1 includes a tube 11 having an inlet end and an outlet end corresponding thereto. An outlet chamber 111 is formed in the tube 11 and near the outlet end, and an inlet chamber 112 is formed in the tube 11 and near the inlet end. The outlet chamber 111 is adapted for receiving a joint 6 of a gas-communicating member. The main body 1 includes a gas-releasing chamber 113 therein, and the tube 11 is formed with a positioning hole 114 near the outlet end. In a preferable embodiment, the gas-releasing chamber 113 is formed by the tube 11 and the blocking member 2.

The blocking member 2 is dispose in the tube 11 and movable between a first position and a second position. The first elastic member 3 is abutted between the main body 1 and the blocking member 2 so as to assist in biasing of the blocking member 2 toward the first position. When the blocking member 2 is located in the first position, the blocking member 2 blocks the positioning hole 114 (via positioning ball 51). When the blocking member 2 is located in the second position, the blocking member 2 unblocks the positioning hole 114.

The gas-communicating mechanism is movable between a third position and a fourth position and includes a passageway 4 communicated with the outlet chamber 111. When the gas-communicating mechanism is located in the third position, the outlet chamber 111 is communicated with the gas-releasing chamber 113 and uncommunicated with the inlet chamber 112. When the gas-communicating mechanism is located in the fourth position, the outlet chamber 111 is communicated with the inlet chamber 112. In a preferable embodiment, the passageway 4 is radially formed at one end of the blocking member 2 and near the inlet chamber 112. When the blocking member 2 is located in the first position, the outlet chamber 111 is communicated with the gas-releasing chamber 113 via the passageway 4 and uncommunicated with the inlet chamber 112. When the blocking member 2 is located in the second position, the outlet chamber 111 is communicated with the inlet chamber 112 via the passageway 4 and uncommunicated with the gas-releasing chamber 113. A hollow blocking plate 115 is fixedly disposed in the tube 11 and a washer 116 is disposed around the blocking member 2, so as to separate and uncommunicate the gas-releasing chamber 113 and the inlet chamber 112.

The positioning sleeve 5 is disposed around the main body 1 and near the outlet end, and the positioning sleeve 5 is movable between a fifth position and a sixth position. The positioning sleeve 5 further includes a positioning mechanism and a second elastic member 52. The second elastic member 52 is abutted between the positioning sleeve 5 and the main body 1 and assists in biasing of the positioning sleeve 5 toward the outlet end of the tube 11. When the positioning sleeve 5 moves toward the outlet end of the tube 11 and is located in the sixth position, the positioning mechanism positions the joint 6 of the gas-communicating member received in the tube 11 via the positioning hole 114.

The positioning mechanism includes a positioning ball 51 and a positioning groove 53. When the blocking member 2 is located in the first position, the blocking member 2 blocks the positioning hole 114 and the positioning ball 51 is located in the positioning hole 114 and the positioning groove 53 so that the positioning ball 51 is unpermitted to move into the tube 11. As such, the positioning sleeve 5 is blocked by the positioning ball 51 so as to locate in the fifth position. When the blocking member 2 is received in the joint 6 of the gas-communicating member of the outlet chamber 111 to drive the blocking member 2 to the second position, the blocking member 2 unblocks the positioning hole 114, the positioning ball 51 goes in the tube 11 to be blocked in the positioning hole 114 and a positioning portion 61 of the joint of the gas-communicating member. The positioning sleeve 5 is not blocked by the positioning ball 51 and pushed by the second elastic member 52, so that the positioning sleeve 5 moves toward the outlet end to the sixth position, while the positioning ball 51 is wedged at the positioning portion 61 so that the joint 6 of the gas-communicating member is unpermitted to be disconnected from the outlet chamber 111. Additionally, one end of the positioning sleeve 5 near the outlet end is formed with an abutting portion 54, and an outer circumferential surface of the tube 11 is formed with an engaging portion 117 near the outlet end. When the positioning sleeve 5 is located in the sixth position, the abutting portion 54 abuts against the engaging portion 117 so as to unpermit movement of the positioning sleeve 5 toward the outlet end.

In a preferable embodiment, the main body 1 further includes a slidable sleeve 12 disposed around the main body 1 and near the inlet end, and the gas-releasing chamber 113 is formed between the slidable sleeve 12 and the tube 11. An inlet passageway 121 is formed between the slidable sleeve 12 and the tube 11, and the inlet passageway 121 and the inlet chamber 112 are communicated with each other. The passageway 4 is formed in the tube 11, and the gas-communicating mechanism is movable between the third position and the fourth position via sliding the slidable sleeve 12. When the gas-communicating mechanism is located in the third position, the passageway 4 is communicated with the gas-releasing chamber 113 and uncommunicated with the inlet passageway 121. When the gas-communicating mechanism is located in the fourth position, the passageway 4 is communicated with the inlet passageway 121 and uncommunicated with the gas-releasing chamber 113. In addition, the blocking plate 115 disposed between the passageway 4 and the inlet chamber 112 can separate the inlet chamber 112 and the outlet chamber 111. Also, the washer 116 which is disposed in the slidable sleeve 12 and between the gas-releasing chamber 113 and the inlet passageway 121 can ensure the gas-releasing chamber 113 and the inlet passageway 121 isolated.

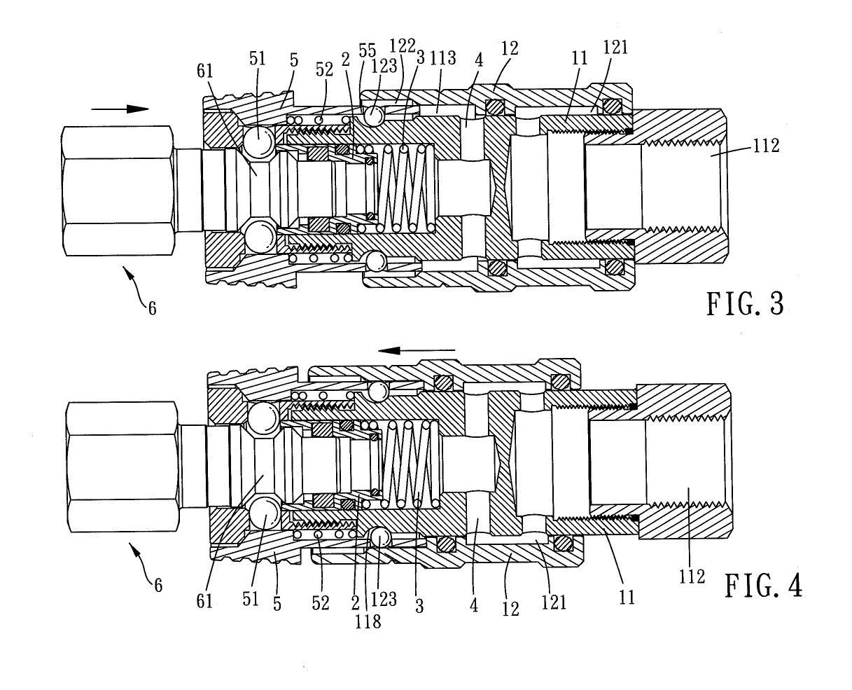

Furthermore, an outer circumferential surface of the tube 11 is formed with a limiting groove 118, the positioning sleeve 5 is formed with a receiving hole 55, and an inner circumferential surface of the slidable sleeve 12 is formed with a receiving recess 122. When the positioning sleeve 5 is located in the fifth position and the gas-communicating mechanism is located in the third position, as shown in FIG. 2, a limiting ball 123 is blocked by the tube 11 so as to locate in the receiving hole 55 and the receiving recess 122. Therefore, when the positioning sleeve 5 is located in the fifth position, the slidable sleeve 12 is unpermitted to move toward the outlet end, so that the slidable sleeve 12 is positioned and the outlet chamber 111 and the inlet chamber 112 are uncommunicated with each other. When the positioning sleeve 5 is located in the sixth position and the gas-communicating mechanism is located in the third position, as shown in FIG. 3, the limiting ball 123 is located in the receiving recess 122, the receiving hole 55 and the limiting groove 118. When the positioning sleeve 5 is located in the sixth position and the gas-communicating mechanism is located in the fourth position, as shown in FIG. 4, the limiting ball 123 is blocked by the slidable sleeve 12 so as to locate in the receiving hole 55 and the limiting groove 118. Therefore, when the slidable sleeve 12 slides toward the outlet end and the gas-communicating mechanism is located in the fourth position, the positioning sleeve 5 is positioned in the sixth position. Through the above structure, when the joint 6 of the gas-communicating member has not be properly positioned in the outlet chamber, the slidable sleeve 12 cannot be slided, thus preventing accident disengagement of the joint 6 of the gas-communicating member when the gas passes therethrough. Besides, when the joint 6 of the gas-communicating member is already properly positioned and the gas passes therethrough, the positioning sleeve 5 is unpermitted to slide to the fifth position so as to allow the removal of the joint 6 of the gas-communicating member if the slidable sleeve 12 is not slid in advance to isolate and uncommunicate the outlet chamber 111 and the inlet chamber. Whereby, only when the gas flow is blocked in advance, the joint 6 of the gas-communicating member is permitted to be removed from the outlet chamber 111 so as to avoid danger.

Moreover, in a preferable embodiment, the abutting portion 54 is formed on one side of the inner circumferential surface of the positioning groove 53 and remote from the engaging portion 117, and the abutting portion 54 is a inclined surface facing the tube 11, so that when the positioning sleeve 5 moves from the fifth position toward the sixth position, the abutting portion (inclined surface) 54 can smoothly push the positioning ball 51 to move toward the interior of the tube 11 to position the joint 6 of the gas-communicating member.

In sum, the quickly-operated adaptor of the invention is provided with the following advantages: with a gas-releasing structure for releasing gas pressure when the joint of the gas-communicating member is being removed, so as to avoid danger of caused by the spurting joint due to the high gas pressure; and with safety installations, the gas flow cannot flow before the joint of the gas-communicating member is properly connected, and the joint of the gas-communicating member cannot disengage unlimitedly from the tube when the inlet chamber and the outlet chamber are communicated with each other.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A quickly-operated adaptor, including:
a main body, including a tube, the tube including an inlet end and an outlet end corresponding thereto, an inlet chamber being formed in the tube and near the inlet end, an outlet chamber being formed in the tube and near the outlet end, the outlet chamber being adapted for receiving a joint of a gas-communicating member, the main body including a gas-releasing chamber therein, and the tube being formed with a positioning hole near the outlet end;
a blocking member, disposed in the tube and being movable between a first position and a second position;
a first elastic member, abutted between the main body and the blocking member for assisting in biasing of the blocking member toward the first position;
a gas-communicating mechanism, being movable between a third position and a fourth position, including a passageway communicated with the outlet chamber, when the gas-communicating mechanism is located in the third position, the outlet chamber is communicated with the gas-releasing chamber via the passageway and uncommunicated with the inlet chamber, and when the gas-communicating mechanism is located in the fourth position, the outlet chamber communicates with the inlet chamber via the passageway;
a slidable sleeve, disposed around the main body and near the inlet end, the gas-releasing chamber formed between the slidable sleeve and the tube, an inlet passageway formed between the slidable sleeve and the tube, the inlet passageway and the inlet chamber communicated with each other, the passageway formed in the tube, the gas-communicating mechanism being movable between the third position and the fourth position via sliding the slidable sleeve, when the gas-communicating mechanism is located in the third position, the passageway is communicated with the gas-releasing chamber and uncommunicated with the inlet passageway, and when the gas-communicating mechanism is located in the fourth position, the passageway is communicated with the inlet passageway and uncommunicated with the gas-releasing chamber; and
a positioning sleeve, disposed around the main body and near the outlet end, and being slidable between a fifth position and a sixth position, wherein when the blocking member is located in the first position, the positioning sleeve is unmovable to the sixth position, and when the blocking member is moved to the second position, the positioning sleeve is moved to the sixth position.

2. The quickly-operated adaptor of claim 1, wherein the positioning sleeve includes a positioning mechanism which includes a positioning ball, the positioning ball is at least partially received in the positioning hole, when the blocking member is located in the first position, the blocking member blocks the positioning hole and the positioning sleeve is blocked by the positioning ball so as to locate in the fifth position, and when the joint of the gas-communicating member is received in the tube so as to drive the blocking member to the second position, the blocking member unblocks the positioning hole and the positioning ball goes in the tube to be blocked at a positioning portion of the joint of the gas-communicating member, and the positioning sleeve is unblocked by the positioning ball so that the positioning sleeve is permitted to move to the sixth position.

3. The quickly-operated adaptor of claim 2, wherein the passageway is radially formed in the tube, the gas-releasing chamber is formed by the tube and the slidable sleeve, when the blocking member is located in the first position, the passageway is communicated only with the gas-releasing chamber and uncommunicated with the inlet chamber, and when the joint of the gas-communicating member is received in the tube to drive the blocking member to the second position, the positioning sleeve moves toward sixth position.

4. The quickly-operated adaptor of claim 2, wherein the positioning sleeve further includes a second elastic member, the second elastic member is abutted between the positioning sleeve and the main body and assists in biasing of the positioning sleeve toward the outlet end of the tube, and when the positioning sleeve moves to the sixth position, the positioning mechanism positions the joint of the gas-communicating member received in the tube via the positioning hole.

5. The quickly-operated adaptor of claim 4, wherein an outer circumferential surface of the tube is formed with a limiting groove, the positioning sleeve is formed with a receiving hole, an inner circumferential surface of the slidable sleeve is formed with a receiving recess, when the positioning sleeve is located in the fifth position, a limiting ball is blocked by the tube so as to locate in the receiving hole and the receiving recess so that the gas-communicating mechanism is limited in third position, when the positioning sleeve is located in the sixth position and the gas-communicating mechanism is located in the third position, the limiting ball is located in the receiving recess, the receiving hole and the limiting groove, when the positioning sleeve is located in the sixth position and the gas-communicating mechanism is located in the fourth position, the limiting ball is blocked by the slidable sleeve so as to locate in the receiving hole and the limiting groove, and when the slidable sleeve is located in the fourth position, the positioning sleeve is positioned in the sixth position.

6. The quickly-operated adaptor of claim 1, wherein an outer circumferential surface of the outlet end of the tube is formed with an engaging portion, one end of the positioning sleeve near the outlet end is formed with an abutting portion, and when the positioning sleeve is located in the sixth position, the abutting portion abuts against the engaging portion so as to unpermit movement of the positioning sleeve toward the outlet end.
